(19) United States
(12) Patent Application Publication
(10) Pub. No.: US 2006/0218831 A1
(43) Pub. Date: Oct. 5, 2006

(54) Method and apparatus for customizing a golf cart

(76) Inventors: Rick Rowe, Las Vegas, NV (US); Stephen T. Moore, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/097,473

(22) Filed: Apr. 1, 2005

(51) Int. Cl. G09F 13/00; G09F 21/04

(52) U.S. Cl. 40/541; 40/442; 40/591

(57) ABSTRACT

A media display permits customization/personalization of a golf cart. The media display comprises a body having a top and bottom surface, and media, such as graphics, lettering or numbering. The media is associated with the body, such as by being located on the top or bottom surface of or being located within, the body. The media display is selectively connectable to a golf cart, preferably at the front or forward portion thereof for displaying the associated media. In accordance with a method, a golf cart is customized by locating a media display at the front of the golf cart, or by replacing or switching media display bearing different media with one another.

### FIELD OF THE INVENTION

The present invention relates to motorized golf cars or carts, and in particular, apparatus for customizing golf cars or carts.

### BACKGROUND OF THE INVENTION

Motorized golf cars or carts are commonly used to transport golfers and their golf clubs during the play of golf. A variety of different configurations of golf carts are known. Some carts are electrically powered, while others use a gas motor. Some carts seat 2 players, while others seat 4.

Generally, all golf carts have a body or shell which extends over the drive elements of the cart. The body is often constructed of fiberglass or similar durable material.

Manufacturers of these golf carts generally make generic styles or models of golf carts. Often, the golf carts are painted a standard white, while in some instances a particular style may be painted red, green or another color. In most instances, however, each golf cart is essentially the same and indistinguishable from ever other golf cart of a particular model or style.

Users of golf carts, including individuals and golf courses, however, often desire to “personalize” the golf carts. For example, a golf course may purchase 50 golf carts for use by its members. The golf course may have a third party paint a logo or apply stickered letters to the body of the golf cart, such as to designate the golf carts as property of the golf course. Individual cart owners may to the same, such as to enable them to distinguish their cart from others' carts.

These methods of “personalizing” the carts, however, have various drawbacks. In general, these methods result in permanent modification to the carts. This lessens the value of the carts to others, such as when an individual wishes to sell their golf cart. In addition, the particular customization prevents use of the cart for other purposes. For example, a golf club may have their logo painted on each cart. If a tournament organizer wishes to conduct a tournament at that club, the organizer may desire that the carts bear the tournament name, rather than the club name.

A convenient method of personalizing one or more golf cars or carts is desired.

### SUMMARY OF THE INVENTION

The invention is a method and apparatus for customizing or personalizing a golf cart.

One embodiment of the invention is a media display for a golf cart. The media display preferably comprises a body having a top side or surface and a bottom side or surface. Media is associated with the body. The media may comprise coloring, lettering, numbering, or art or graphics, such as logos. The media may be associated with the top and/or bottom sides, or be located within the body.

In one embodiment, the body is generally rigid, such as by being constructed of molded or formed plastic, acrylic or fiberglass. The body may have various configurations, including shapes and sizes. Preferably, the body is configured to fit on or over at least a portion of the front or forward portion of a golf cart. In one embodiment, the body is generic in configuration for mating with golf carts of various configurations. In another embodiment, the body has a particular configuration for mating with a particular style or configuration of golf cart. For example, in one embodiment the body may be generally rectangular in shape for location over the front of any golf cart having sufficient area for accepting the display. In another embodiment, the body may be configured to include headlight or bumper cut-outs and/or be molded to conform to the front of a particularly styled golf cart having headlights and front area of various elevations/slopes.

Means are provided for connecting one or more media displays to a golf cart. In a preferred embodiment, the means permits a media display to be selectively connected to a golf cart, thus facilitating both ease of connection and disconnection from a golf cart. In one embodiment, the means comprises mating hook and loop material, threaded fasteners or the like.

In accordance with a method of the invention, a golf cart is customized or personalized by associating a media display with the golf cart. Preferably, the media display displays particular media and is located at the front or forward portion of the golf cart. Association of the media display with the golf cart permits the golf cart to be customized to bear particular logos, text or the like. Further, the media display maybe modified, such as to display other media, or a replacement media display maybe connected to the golf cart in order to change the configuration of the cart.

Further objects, features, and advantages of the present invention over the prior art will become apparent from the detailed description of the drawings which follows, when considered with the attached figures.

### DESCRIPTION OF THE DRAWINGS

FIG. 1 illustrates a media display in accordance with a first embodiment of the invention, the media display for association with a golf cart;

FIG. 2 illustrates another embodiment media display of the invention, the media display for association with a golf cart;

FIG. 3A illustrates one means for selectively connecting a media display of the invention to a golf cart; and

FIG. 3B illustrates another means for selectively connecting a media display of the invention to a golf cart.

### DETAILED DESCRIPTION OF THE INVENTION

The invention comprises a method and apparatus for personalizing a golf car or cart. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Various embodiments of the invention comprise a media display for association with a golf car or cart. The media display comprises a member configured to display media or information such as text, artistic designs, logos or the like. Other embodiments of the invention comprise methods of personalizing a golf cart, including a method of associating a media display of the invention with a golf cart.

Preferably, the media display of the invention is configured for use with a golf car or cart. Various embodiments of such cars or carts are known in the art. These cars or carts are generally motorized and are configured to transport one or more golfers and their equipment about a golf course. Golf carts may be powered in various manners, such as by electric and/or gasoline powered motors or engines. The carts are generally supported by one or more wheels. Common configurations include three and four-wheeled carts. The carts generally have a body or shell which is mounted over the drive components of the cart, and which provides support for the golfer(s) and their equipment.

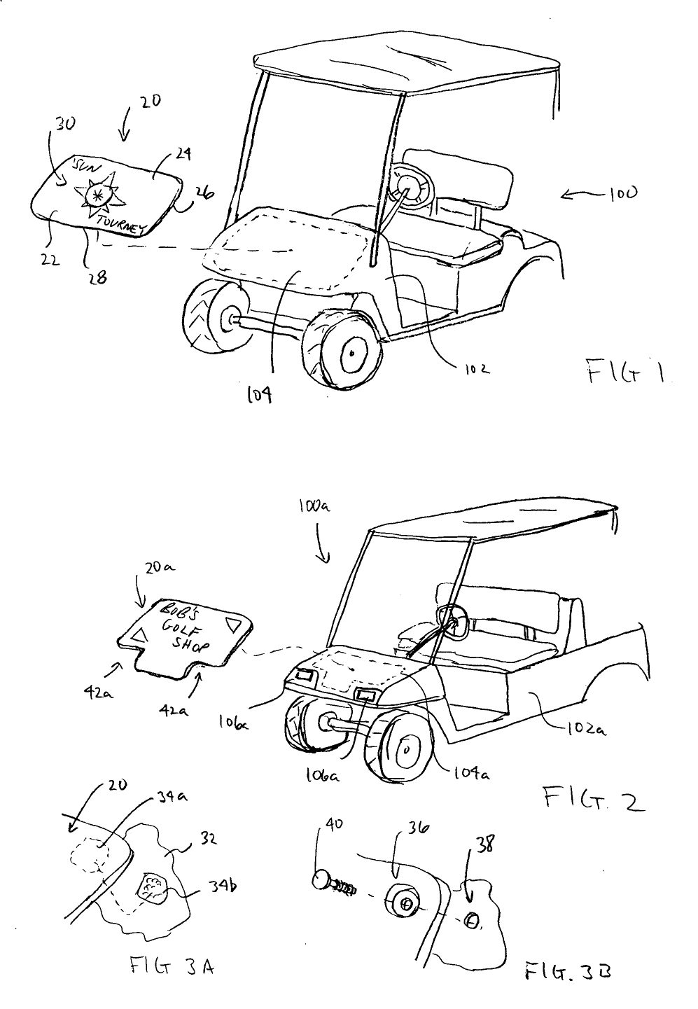

FIGS. 1 and 2 illustrate just two embodiments of golf carts to which the invention is applicable. It will be appreciated that the principles of the invention maybe applied to golf carts of many different configurations as now known or later developed.

FIG. 1 illustrates one embodiment of a media display 20 in accordance with the invention. As illustrated, the media 20 comprises a body or support 22. In one embodiment, the body 22 of the media 20 has a first side or surface 24, an opposing second side or surface 26 and peripheral edge 28. Preferably, the body 22 is thin in dimension between its first and second sides 24,26. For example, the body 22 may have a thickness of about 0.10 inches to about 1 inch.

In one embodiment, the body 22 is relatively rigid to constantly maintain its desired shape. The body 22 maybe sufficiently flexible, however, to aid it in molding or mirroring the shape of a portion of a golf cart to which it is attached. In a preferred embodiment, the body 22 is constructed from plastic, acrylic, fiberglass or the like, such as in a molding process.

In one embodiment, the body 22 is constructed of a clear or transparent material. In this manner, as detailed below, the structure of the cart to which the media 20 is applied is visible through the body 22. In another embodiment, the body 22 is opaque, preventing or reducing visibility there-through.

The body 22 is configured to support and display information, such as text, graphics or artwork or the like. In one embodiment, media 30 is associated with the body 22. The media 30 maybe applied to the body 22, such as by painting the body 22, laminating or covering one or more surfaces of the body 22, etching (such as with a laser, tool, or sandblasting process) the body 22, or embedding material within the body 22, such as by embedding molding or similar material into the body (for example, embedding formed letters into body). In one embodiment, the media 30 is associated with the first or top surface 24 of the body 22. For example, one or more areas of the top surface of the body 22 may be painted. In another embodiment, the media 30 is embedded within or is associated with the second or bottom surface 26 of the body 22. These embodiments have the advantage that the body 22 protects the media 30 from damage, such as impact with objects and the weather.

When the media 30 is embedded within the body 22, the media 30 may comprise coloring or even a physical structure, such as metal, wood or other elements. In one embodiment, media 30 may be applied to one or more surfaces of the body 22 and/or be embedded or located within the body 22. For example, the body 22 may be molded with a coloring to provide a colored background to other media 30 which is applied to the top surface 24 of the body 22.

The media 30 may comprise or be associated with a sheet of material which is selectively applied to the body 22, or comprise a wide range of other physical elements applied to the body, such as lettering constructed from wood, plastic, metal or the like.

The media display 20 is configured for association with a golf cart. In one embodiment, means are provided for selectively attaching a media display 20 to a golf cart. In the preferred embodiment, this means preferably allows the media display 20 to be readily connected to and disconnected from, the golf cart.

FIGS. 3A and 3B illustrate two embodiments of apparatus and methods for selectively connecting the media display 20 to a member or surface 32 of a golf cart. In the embodiment illustrated in FIG. 3A, first and second mating portions 34a,b of hook and loop fastening material are connected to the media display 20 and golf cart member 32, respectively. As illustrated, one of the portions 34a is connected to and extends from the bottom surface of the body of the media display, while the other portion 34b is located on an outer surface of a portion of the golf cart. These portions 34a,b permit fastening of the media display 20 to a golf cart. It will be appreciated that a plurality of mating portions of hook and loop material, in various locations, may be utilized to connect the media display 20 to the golf cart.

FIG. 3B illustrates another embodiment of means for connecting. As illustrated, the media display 20 has a passage 36 there through for alignment with a mating passage 38 in an element of a golf cart. A fastener 40 is configured to pass through the passage or aperture 36 in the media display 20 into engagement with the passage or aperture 38 in the golf cart member. The fastener 40 may be secured by connection to another member (such as a nut threaded onto the fastener), or by connection to the golf cart member (such as threads in the passage 38 or by press-fit, frictional engagement or other means). One or more fasteners may be used to connect the media display 20 to the golf cart.

Other means maybe provided for connecting the media display 20 to a golf cart. For example, suction cups, snaps, clips and other types of fastening devices maybe utilized. Preferably, the manner of fastening allows the media display 20 to be connected to and disconnected from a cart without damaging the media display 20 or the cart.

The media display 20 may have a variety of shapes and configurations. In a preferred embodiment, the media display 20 is configured to be mounted to the front or forward portion of a golf cart. As such, the media display 20 is preferably sized and shaped to fit the front portion of the golf cart to which it is to be attached. In one embodiment, the media display 20 maybe particularly configured for connection to a particular type or style of golf cart. In another embodiment, “generic” configurations of media display 20 maybe provided, those media display 20 capable of being connected to golf carts having a variety of different configurations.

FIG. 1 illustrates one embodiment of a media display 20 which is “generic” in configuration. As illustrated, the media display 20 is generally rectangular in peripheral shape. The size of the media display 20 may vary. In one embodiment, the media display 20 is about 12-26 inches wide and about 6 to 24 inches tall. In such an embodiment, the media display 20 maybe connected to a wide variety of golf carts.

FIG. 1 illustrates one embodiment of a golf cart 100 to which the media display 20 may be connected. As illustrated, the golf cart 100 has a body or shell 102 which defines a sloping front 104 or nose. As indicated above, the shell 102 may be constructed, for example, from fiberglass.

In the embodiment illustrated, the front 104 of the golf cart 100 is a generally planar surface. The media display 20 is sized to be located above the front 104 of the golf cart 100. Preferably, the media display 20 is connected to the golf cart 100, such as in the manner described above and illustrated in FIGS. 3A and 3B.

It will be appreciated that so long as the golf cart 100 has at least one surface which is sufficiently large to accept the media display 20, the media display 20 maybe connected to such a cart, regardless of the particular configuration of the cart.

FIG. 2 illustrates another embodiment media display 20a in accordance with the invention. This embodiment media display 20a is particularly configured, such as for connection to a particular style of golf cart. The media display 20a as illustrated in FIG. 2 is particularly configured to be associated with a golf cart 100a having the configuration illustrated.

As illustrated, the golf cart 100a has a body or shell 102a which defines a front 104a. In this embodiment, however, a pair of headlights 106a are located at the front of the golf cart 100a. The headlights 106a are spaced from one another, leaving an open portion of the front 104a of the cart 100a between and above them.

In one embodiment, the media display 20a is configured to be located over the front 104a of the golf cart 100a, but not cover or obscure the headlights 106a. As such, the media display 20a has a pair of cut-away areas 42a (which maybe formed by molding or actually cutting away material of the body of the media display). Once again, the media display 20a is preferably connected to the golf cart 100a, such as by one or more of the fastening techniques described above.

In some embodiments, the media display of the invention may be general planar. In other embodiments, the media display maybe shaped and have various elevations. For example, referring to the golf cart 100a illustrated in FIG. 2, the portion of the front 104a between the headlights 106a slopes downwardly relative to the portion of the front which is located above the headlights. In one embodiment, the media display 20a thus has a similar shape, having a generally planar upper section and a downwardly bending or sloping section between the cut-way areas 42a.

Of course, the shape and configuration of the media display of the invention may, as indicated above, vary tremendously. In one embodiment, however, the media display is preferably sized to define a large display area. As such, it is desirable for the media display to extend over a significant portion of the front of a golf cart. The media display may thus be configured to extend generally from a first side to a second side of the front of the cart, and from a top portion of the front to a bottom portion of the front (such as defined by a bumper or trim of the cart). The media display may even be configured to “wrap-around” to and cover a portion of the sides of the cart at the front or forward end of the cart. In a preferred embodiment, the media display is configured to be located at a “nose” portion of the golf cart where it is readily visible to both the driver and any passengers of the golf cart, as well as third parties.

In one embodiment, when the media display is connected to a golf cart, it is spaced therefrom so as to not trap dust, dirt or water beneath it. For example, the media display may include one or more protrusions, such as molded dimples, attached rubber spacers or the like, which set or space the media display (or the majority thereof) away from the golf cart by some distance. Similarly, the fasteners may define such a spacing, such as by using washers or the like.

In another embodiment, a gasket or the like may be located between the media display and the cart for sealing the media display to the cart. Such a gasket or gaskets maybe used to prevent moisture and dirt from becoming lodged between the media display and cart. In other embodiments, a peripheral edge of the media display maybe configured to conform to the cart or even engage a mating slot formed in the cart for such a sealing purpose.

In one embodiment, means maybe provided for illuminating the media display, or at least media associated therewith. Various forms of lighting, such as LED's, flourescent, incandescent, and neon light-emitting devices maybe associated with the media display. These light-emitting devices may have a variety of configurations. In one embodiment, the light-emitting devices maybe configured to operate at low voltages permitting them to be powered by the engine/battery of the golf cart or other vehicle with which they are associated.

The light-emitting device(s) maybe mounted to the media display or mounted in close proximity thereto. Preferably, the light-emitting device(s) is configured to illuminate at least a portion of the media display. For example, the light-emitting device(s) maybe located under the media display for back-lighting the media thereon. The light-emitting device(s) may also be located in the media display (such as embedded therein or located between two layers of the media display. The light-emitting device(s) may be located along the periphery of the media display for illuminating the edges. In one embodiment, where the media display is constructed of an acrylic or similar material, the light-emitting device(s) may be configured to direct light into the edges of the media display, causing the entire body of the media display to be illuminated due to the internal distribution of light by the acrylic material.

Various aspects of the invention will now be appreciated. In accordance with the invention, a media display permits personalization of a golf cart. The media display is capable of carrying or displaying various media including text, artwork including logos and other graphics, numbers, designs and other elements. The media may thus include or comprise advertising, such as illustrated in FIG. 2, special event information, such as illustrated in FIG. 1, or cart ownership information, such as the name of the individual or club owner of the cart, among other things.

The media display permits customization of a golf cart by associating the media display with a golf cart. For example, if a tournament is to be held at a golf club, the carts maybe customized with media display bearing the name and logo of the tournament, as illustrated in FIG. 1. An individual or golf club may associate their name, a design or the material with their cart(s) via the media display, such as to personalize the cart(s) and make them different or identifiable from other carts.

Advantageously, while the invention permits a golf cart to be customized or personalized, the media display maybe disassociated from the golf cart to remove the customization or personalization, and maybe changed with another media display or an altered media display, thus changing the customization or personalization of the cart. For example, a golf club may have one set of media display bearing the club's logo which are normally affixed to the club's carts. In the event of a tournament or use by a special guest, the media display bearing the club logo may be removed from one or more carts and replaced with another media displaying tournament or special guest information or media.

In one embodiment, a particular media display maybe used to display various different media. For example, a thin printed laminate sheet may be applied to a media display, that sheet carrying or displaying a club logo. That sheet maybe peeled off of the body of the media display and a different sheet may be connected in order to display different media. Likewise, painting, lettering or other materials may be connected to and removed from the body of the media display in order to change the media which is displayed.

In one embodiment, the media display may be opaque to hide or block the area of the cart beneath the media display. For example, the media display maybe used to modify golf carts which are already painted with a club logo. When an opaque media display is located over that portion of the cart, the club logo is no longer visible (but other media displayed by the media display will be) and by removing the media display, the golf cart may be returned to its original condition.

In another embodiment, the media display maybe translucent, permitting the portion of the cart there beneath to be visible.

The invention may be applied to other types of vehicles, such as ATV's, cars, trucks, low-emissions vehicles (LEVs), tractors and the like, though the invention has particular applicability to golf cars or carts.

It will be understood that the above described arrangements of apparatus and the method there from are merely illustrative of applications of the principles of this invention and many other embodiments and modifications maybe made without departing from the spirit and scope of the invention as defined in the claims.

What is claimed is:

1. A method of customizing a motorized golf cart having a body with a front comprising:
providing a media display, said media display comprising a body having a top surface and a bottom surface, said body being generally rigid, and said media display including media associated with said body,
locating said media display over at least a portion of said front of said golf cart; and
detachably connecting said media display to said golf cart so that said media associated with said body of said media display is visible and in a manner permitting said media display to be disconnected from said golf cart.

2. The method in accordance with claim 1 including the step of sealing said media display to said golf cart.

3. The method in accordance with claim 2 wherein said step of sealing comprises positioning at least one weatherproofing element between said media display and said golf cart.

4. The method in accordance with claim 1 including the step of associating said media with said media display.

5. The method in accordance with claim 4 wherein said step of associating said media is selected from the group consisting of: associating stickers with said body, painting one or more portions of said body, etching one or more portions of said body, embedding one or more elements in said body, and locating a sheet material on said body.

6. The method in accordance with claim 1 wherein said body is transparent.

7. The method in accordance with claim 1 wherein said golf cart has a sloping nose portion at said front and said media display is positioned over at least a portion of said nose portion.

8. The method in accordance with claim 1 wherein said step of detachably connecting comprises placing mating hook and loop fastening material associated with said body and said golf cart into engagement.

9. The method in accordance with claim 1 wherein said step of detachably connecting comprises placing one or more suction cups extending from said media display into engagement with said golf cart.

10. The method in accordance with claim 1 wherein said step of detachably connecting comprises engaging at least one fastener with said body of said media display and a body of said golf cart.

11. The method in accordance with claim 1 including the step of providing at least one light-emitting element configured to illuminate at least a portion of said media display.

12. A media display for a motorized vehicle comprising:
a body having a top surface, a bottom surface and a peripheral edge, said body being generally rigid, and said body configured to fit over at least a front portion of a vehicle;
media associated with said body; and
means for fastening said body said vehicle.

13. The media display in accordance with claim 12 including at least one light emitting element configured to illuminate at least a portion of said body.

14. The media display in accordance with claim 12 wherein said means for fastening comprises at least one suction cup.

15. The media display in accordance with claim 12 wherein said media is embedded in said body.

16. The media display in accordance with claim 12 including one or more projections extending from said bottom surface of said body configured to space said body from said vehicle.

17. The media display in accordance with claim 12 wherein said body has a first section and at least one second section, said first and second sections extending at different angles to one another corresponding to a contour of a portion of said vehicle over which said body is to be located.

18. The media display in accordance with claim 12 wherein said media is defined by one or more elements selected from the group consisting of: stickers, a laminate sheet, paint, or material embedded in said body.

19. The media display in accordance with claim 12 wherein said media is defined by etching a surface of said body.

20. The media display in accordance with claim 12 including at least one gasket position near said peripheral edge of said body at said bottom of said body configured to seal said body to a surface of said value.
